(19) United States
(12) Patent Application Publication
(10) Pub. No.: US 2004/0218675 A1
(43) Pub. Date: Nov. 4, 2004

(54) Method and apparatus for determining reference picture and block mode for fast motion estimation

(75) Inventors: So-young Kim, Seoul (KR); Hyeong-seok Ha, Suwon-si (KR); Nam-suk Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/827,405

(22) Filed: Apr. 20, 2004

(30) Foreign Application Priority Data
Apr. 30, 2003 (KR) 2003-27540

(51) Int. Cl. H04N 7/12

(52) U.S. Cl. 375/240.16; 375/240.12; 375/240.24

(57) ABSTRACT

Provided are a method and apparatus for determining a reference picture and a block mode for fast motion estimation. The method of determining a block mode includes determining motion vectors of respective first sub blocks of an input video data block by performing motion estimation on the video data block in a mode of the first sub blocks, and determining a block mode depending on whether the motion vectors are similar when it is determined there is no need to perform motion estimation on the video data block in a mode of second sub blocks that is smaller than the mode of the first sub blocks. Accordingly, it is possible to remarkably reduce a number of performing motion estimation by using result of motion estimation performed in a block mode, thereby enabling a reference picture and a block mode to be determined with less calculation.

This application claims the priority of Korean Patent Application No. 2003-27540 filed on Apr. 30, 2003 in the Korean Intellectual Property Office, the disclosure of which is incorporated herein in its entirety by reference.

### BACKGROUND OF THE INVENTION

1. Field of the Invention

The present invention relates to fast motion estimation for inter prediction coding, and more particularly, to a method and apparatus for determining a reference picture and a block mode for fast motion estimation.

2. Description of the Related Art

A moving picture consists of a plurality of frames, and the plurality of frames are continuously displayed thus allowing a user to view the moving picture. According to the characteristics of an image signal, there is a similarity between adjacent frames, between adjacent blocks, or between pixels of the same frame.

It is possible to highly efficiently compress an image signal by prediction coding the image signal based on the similarity in the image signal. Prediction coding is classified into inter prediction coding using the similarity between adjacent frames and intra prediction coding using the similarity in an image signal.

More specifically, inter prediction coding is performed by dividing image data contained in a current frame into predetermined units, e.g., units of 16×16 pixel macro blocks, searching for previous frames on a macro block basis, and accomplishing motion estimation. A previous frame used for motion estimation is referred to as a reference frame.

In motion estimation, a macro block, which is the most similar to a macro block in the current frame, is searched for in the previous frames using a measure function, and a motion vector representation of the difference between locations of the macro block in the current frame and the searched macro block is obtained.

Motion estimation can be realized using various methods. For instance, motion estimation is performed using a plurality of reference pictures according to the ITU-T H.26L video compression standard. Also, motion estimation is not limited to a macro block mode, that is, motion estimation can be performed in various sized block modes thus improving encoding efficiency.

FIG. 1 illustrates a current picture P_{C}, and N reference pictures P₀ through P_{N-1} used for motion estimation of the current picture. For inter prediction encoding, motion estimation is performed on the current picture P_{C} on a predetermined block basis using the N reference pictures P₀ through P_{N-1}.

FIG. 2 illustrates various block modes in which motion estimation is performed. Referring to FIG. 2, (a) through (d) denote a 16×16 block mode, a 16×8 block mode, an 8×16 block mode, and an 8×8 block mode, respectively.

As shown in FIG. 2(e) through (h), motion estimation can be performed on an 8×8 block in an 8×8 block mode, an 8×4 block mode, a 4×8 block mode, or a 4×4 block mode.

As apparent from FIG. 2, if the number of block modes is seven, there are nineteen block modes in which motion estimation can be performed on a 16×16 macro block. Further, when a plurality of reference pictures are offered, a number of block modes available on a macro block basis is very large.

Referring to FIG. 1, if a number of reference pictures is N, a number of block modes available for motion estimation using all the reference pictures is 9×N.

A motion vector is obtained by performing motion estimation on the respective reference pictures in all block modes available, and a reference picture and a block mode, which lead to the highest compression efficiency, are determined using the motion vector. Therefore, it is possible to increase bit rate efficiency and compress images so as to obtain higher definition of the images with a reduced bit rate.

However, when an image encoder performs motion estimation on a plurality of reference pictures in various block modes, the amount of calculation is very large, thus remarkably increasing complexity.

Even if motion estimation is performed on only one reference picture, it is impossible to largely reduce the amount of calculation, i.e., the complexity, because motion estimation must be done in various block modes.

### SUMMARY OF THE INVENTION

The present invention provides a method and apparatus for determining a reference picture and a block mode with less calculation when performing motion estimation on a plurality of reference pictures in a plurality of block modes.

The present invention also provides a method and apparatus for determining a block mode with less calculation when performing motion estimation on a reference picture in a plurality of block modes.

According to an embodiment of the present invention, there is provided a method of determining a reference picture and a block mode, the method including a method of determining a reference picture and a block mode, the method comprising (a) dividing a video data block of a predetermined size into 2M first sub blocks, wherein M is an integer that equals or is larger than 1; (b) selecting reference pictures for motion estimation on the respective 2M first sub blocks from N reference pictures, wherein N is an integer that equals or is larger than 2; (c) counting a number of the first sub blocks that use the same reference picture; (d) determining whether there are two adjacent first sub blocks using the same reference picture when a number of the first sub blocks using the same reference picture is two or more and is (2M−1) or less; and (e) when there are two adjacent first sub blocks using the same reference picture, determining a reference picture and a block mode depending on whether two motion vectors are similar, the two motion vectors obtained by performing motion estimation on the two respective adjacent first sub blocks.

According to another embodiment of the present invention, there is provided an apparatus for determining a reference picture and a block mode, the apparatus comprising a block divider that divides an input video data block of a predetermined size into 2M first sub blocks, wherein M is an integer that equals or is larger than 1; a motion estimator that receives N reference pictures, receives the 2M first sub blocks from the block divider, and performs motion estimation on the respective first sub blocks using the N reference pictures, wherein N is an integer that equals or is larger than 2; and a reference picture/block mode determination unit that determines a reference picture, which is used when obtaining the highest accuracy of the result of motion estimation received from the motion estimator, as a reference picture for the first sub blocks using the N reference pictures, and N reference values that indicate accuracy of the result of motion estimation performed on the respective first sub blocks N times, and receives, from the motion estimator, two motion vectors obtained by performing motion estimation on two adjacent first sub blocks using the same reference picture and determines a reference picture and a block mode depending on whether the two motion vectors are similar, when a number of the first sub blocks using the same reference picture is two or more and (2M−1) or less and two adjacent first sub blocks using the same reference picture are present.

According to yet another embodiment of the present invention, there is provided a method of determining a block mode, the method including (a) performing motion estimation on an input video data block in a mode of first sub blocks thereof using a predetermined reference picture and a predetermined measure function for motion estimation, and obtaining values of the measure function and motion vectors for the respective first sub blocks; (b) determining whether there is a need to perform motion estimation on the video data block in a mode of second sub blocks thereof which are smaller than the mode of the first sub blocks; and (c) when there is no need to perform motion estimation on the video data block in the mode of the second sub blocks, determining a block mode of the video data block depending on whether motion vectors of the first sub blocks are similar.

According to still another embodiment of the present invention, there is provided an apparatus for determining a reference picture and a block mode, the apparatus comprising a block divider that divides a video data block into a plurality of first sub blocks; a motion estimator that determines values of measure function and motion vectors of the respective first sub blocks by receiving N predetermined reference pictures, receiving the plurality of first sub blocks from the block divider, and performing motion estimation on the video data block in a mode of the first sub blocks using the N reference pictures and a predetermined measure function for motion estimation; and a block mode determination unit that determines a block mode depending on whether motion vectors of the respective first sub blocks are similar, when it is determined that there is no need to perform motion estimation on the video data block in a mode of second sub blocks that is smaller than the mode of the first sub blocks, using a plurality of values of measure function calculated by performing motion estimation on the first sub blocks received from the motion estimator.

### BRIEF DESCRIPTION OF THE DRAWINGS

The above and other aspects and advantages of the present invention will become more apparent by describing in detail exemplary embodiments thereof with reference to the attached drawings in which:

FIG. 1 illustrates a current picture and a plurality of reference pictures used for motion estimation of the current picture;

FIG. 2 illustrates various block modes for motion estimation;

FIG. 3 is a block diagram of a moving picture encoding apparatus according to an embodiment of the present invention;

FIG. 4 is a block diagram of an apparatus for determining a reference picture and a block mode according to an embodiment of the present invention;

FIG. 5 illustrates an example of dividing an input macro block into four 8×8 sub blocks;

FIG. 6A is a flowchart illustrating a method of determining a reference picture and a block mode according to an embodiment of the present invention;

FIG. 6B is a flowchart illustrating a method of determining a reference picture and a block mode for motion estimation when the number of sub blocks using the same reference picture is two, according to an embodiment of the present invention;

FIGS. 6C and 6D illustrate flowcharts illustrating a method of determining a reference picture and a block mode for motion estimation when the number of sub blocks using the same reference picture is three, according to an embodiment of the present invention;

FIG. 7 is a detailed flowchart illustrating step 212 of FIG. 6A;

FIG. 8 is a block diagram of an apparatus for determining a block mode according to an embodiment of the present invention;

FIG. 9 is a flowchart illustrating a method of determining a block mode according to an embodiment of the present invention;

FIG. 10 illustrates values of a sum-of-absolute-difference (SAD) function, which are stored in 4×4 block unit;

FIG. 11 is a detailed flowchart illustrating step 500 of FIG. 9;

FIG. 12 is a detailed flowchart illustrating step 600 of FIG. 9;

FIG. 13 is a detailed flowchart illustrating step 800 of FIG. 9; and

FIG. 14 is a detailed flowchart illustrating step 900 of FIG. 9.

### DETAILED DESCRIPTION OF THE ILLUSTRATIVE, NON-LIMITING EMBODIMENTS OF THE INVENTION

Hereinafter, illustrative, non-limiting embodiments of the present invention will be described in detail with reference to the accompanying drawings.

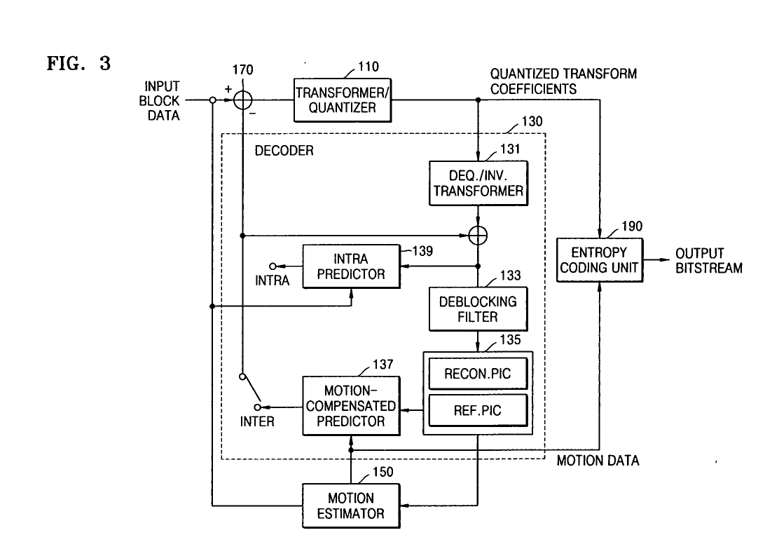

FIG. 3 is a block diagram of a moving picture encoding apparatus according to an embodiment of the present invention. Referring to FIG. 3, the moving picture encoding apparatus includes a transformer/quantizer 110, a dequantizer/inverse transform 131, a deblocking filter 133, a picture reproduction unit 135, a motion compensated predictor 137, an intra predictor 139, a motion estimator 150, a subtracter 170, and an entropy coding unit 190.

Image data is input to the moving picture encoding apparatus of FIG. 3 in units of 16×16 pixel macro blocks.

The transformer/quantizer 110 transforms input macro blocks in a predetermined manner and quantizes the result of transformation. A discrete cosine transform (DCT) is commonly used as the image conversion technique.

The dequantizer/inverse transformer 131 receives DCTed and quantized image data from the transformer/quantizer 110, inversely quantizes the image data, and performs inverse DCT on the inversely quantized image data.

The deblocking filter 133 receives the inversely quantized DCT image data from the dequantizer/inverse transformer 131 and filters it to remove blocking effect therefrom.

The picture reproduction unit 135 receives the filtered image data from the deblocking filter 133 and reproduces and stores it in picture units. Here, a picture denotes an image in units of frames or fields. The picture reproduction unit 135 includes a buffer (not shown) capable of storing a plurality of pictures. The plurality of pictures stored in the buffer are provided for motion estimation and will be referred to as reference pictures in this disclosure.

The motion estimator 150 is provided with at least one reference picture from the picture reproduction unit 135, performs motion estimation on the reference picture on an input macro block basis, and outputs motion data that includes a motion vector, an index indicating the reference picture, and a block mode.

The motion compensated predictor 137 receives the motion data from the motion estimator 150 and extracts and outputs a macro block corresponding to the input macro block using a reference picture, which is used for motion estimation, selected from the plurality of reference pictures stored in the picture reproduction unit 135, based on the motion data.

For inter prediction coding of the input macro block, the subtracter 170 receives a macro block of the reference picture corresponding to the input macro block from the motion compensated predictor 137, performs a subtraction operation between the received macro block and the input macro block, and outputs the result of subtraction as a residue signal.

The residue signal output from the subtracter 170 is transformed and quantized by the transformer/quantizer 110, and entropy-encoded by the entropy coding unit 190, and generated as an output bit stream.

The intra predictor 139 performs intra prediction coding, other than inter prediction coding, using the reference picture.

A moving picture decoding unit 133, which decodes the bit stream generated by the moving picture encoding apparatus, includes the dequantizer/inverse transformer 131, the deblocking filter 133, the picture reproduction unit 135, the motion compensated predictor 137, and the intra prediction unit 139.

Hereinafter, determination of a reference picture and a block mode when performing motion estimation on a plurality of reference pictures in a plurality of block modes, according to the present invention, will be described.

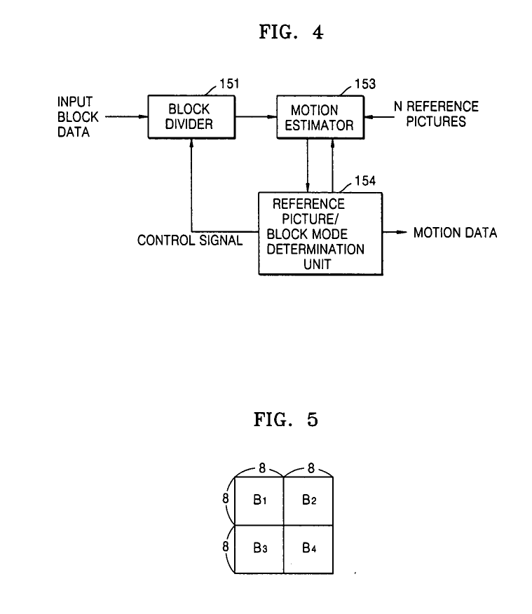

FIG. 4 is a block diagram of an apparatus for determining a reference picture and a block mode according to an embodiment of the present invention. The apparatus of FIG. 4 includes a block divider 151, a motion estimator 153, and a reference picture/block mode determination unit 154.

The apparatus of FIG. 4 may be equivalent to the motion estimator 150 included in the moving picture encoding apparatus of FIG. 3 or be included in the motion estimator 150, and perform a method of determining a reference picture and a block mode according to the present invention.

The block divider 151 receives input block data, i.e., image data in macro block units, divides the macro block into predetermined sized sub blocks, and outputs the image data in the sub block units.

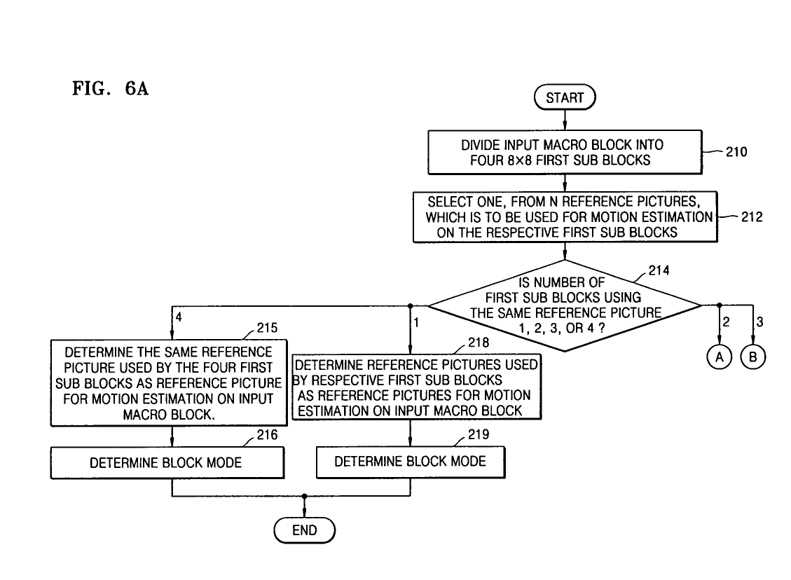

FIG. 5 illustrates an example of an input macro block that is divided into four 8×8 sub blocks B₁, B₂, B₃, and B₄ using the block divider 151.

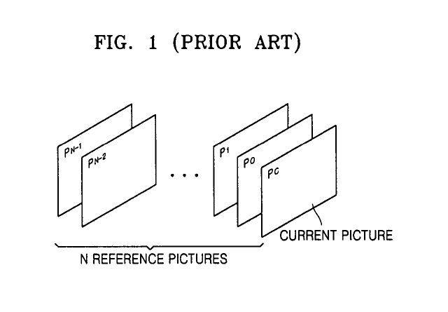

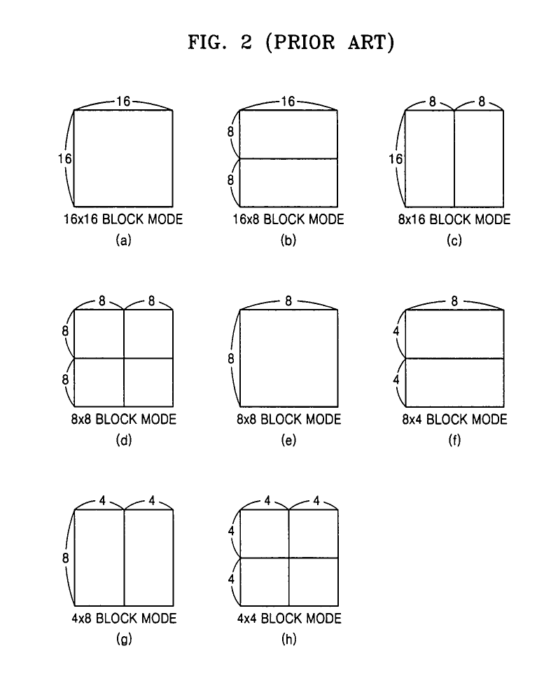

The motion estimator 153 of FIG. 4 receives N reference pictures as shown in FIG. 1 and 8×8 sub blocks from the block divider 151, and performs motion estimation using them.

The reference picture/block mode determination unit 154 receives data, for determining a reference picture and a block mode, from the motion estimator 153, determines a reference picture and a block mode, and outputs motion data including an index of a reference picture used for motion estimation, a block mode, and a motion vector.

A method, according to the present invention, which determines a reference picture and a block mode according to the present invention using an apparatus according to the present invention, will now be described.

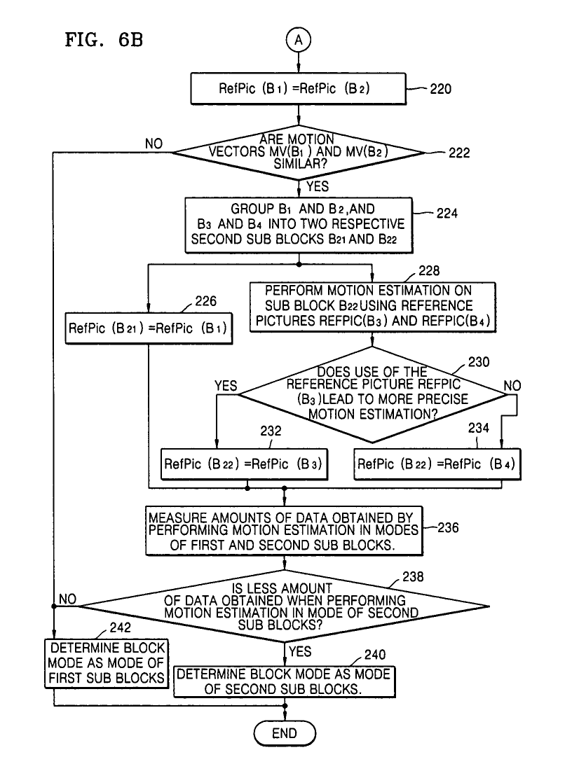

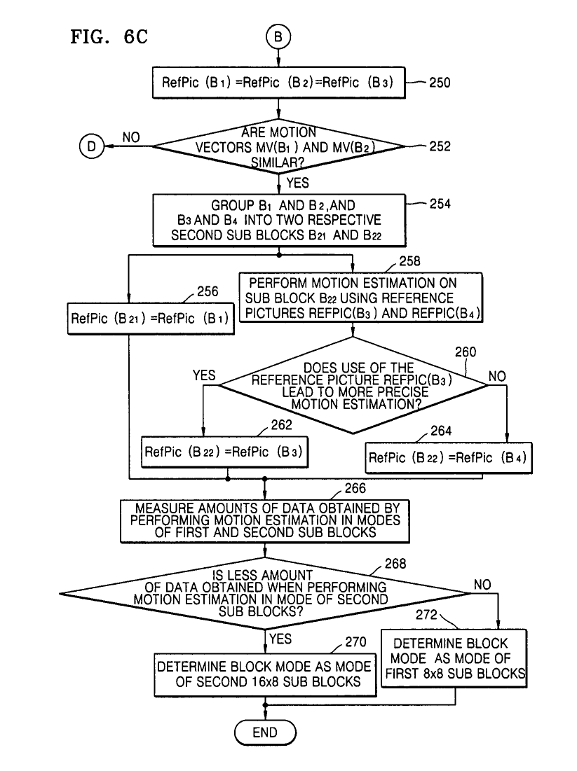

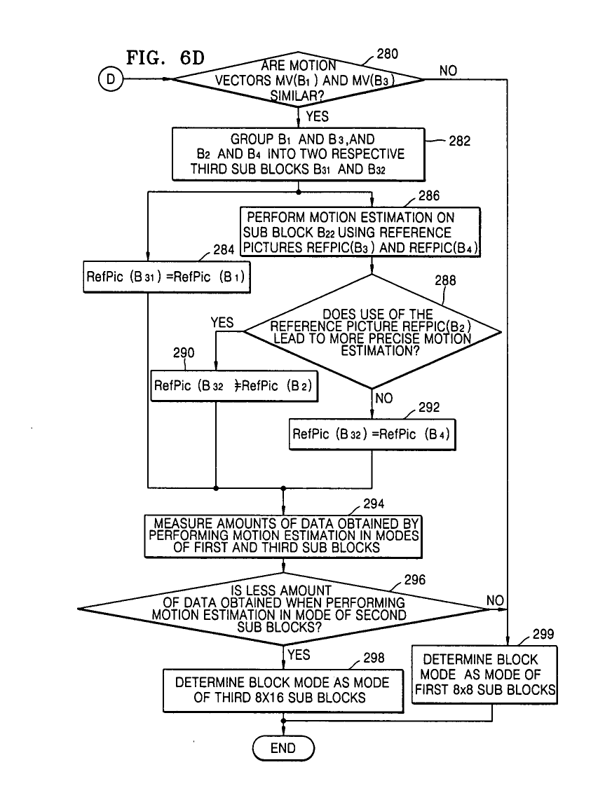

FIGS. 6A through 6D are flowcharts illustrating a method of determining a reference picture and a block mode, according to embodiments of the present invention.

Referring to FIG. 6A, the block divider 151 divides an input macro block into four 8×8 sub blocks B₁, B₂, B₃, and B₄ as shown in FIG. 5 (step 210).

Next, the motion estimator 153 sequentially receives four 8×8 sub blocks B₁, B₂, B₃, and B₄ from the block divider 151 and determines four pictures for motion estimation of the respective four sub blocks B₁, B₂, B₃, and B₄, using N reference pictures such as that shown in FIG. 1 (step 212).

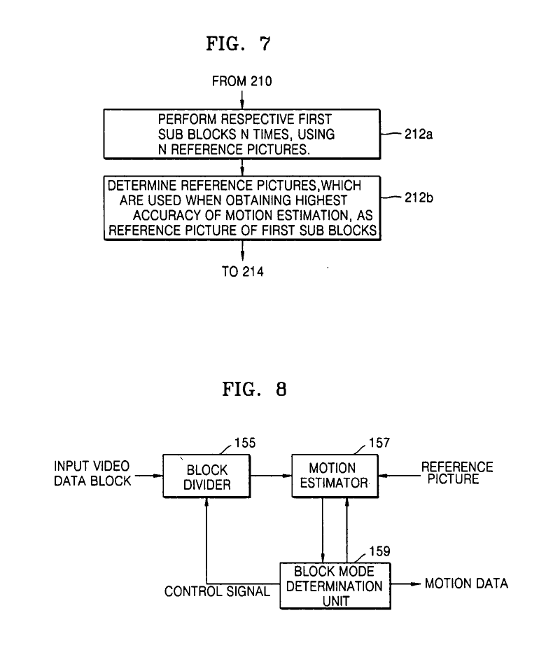

FIG. 7 is a detailed flowchart illustrating step 212 of FIG. 6A. The motion estimator 153 reads one of the N reference pictures from the picture reproducing unit 135 and performs motion estimation on the respective 8×8 sub blocks B₁, B₂, B₃, and B₄ N times (step 212a).

In general, motion estimation is performed using a measure function, such as a sum-of-absolute-difference (SAD) function, for predetermined motion estimation. A value of the SAD function is obtained by combining the absolute values of differences between the values of pixels of an 8×8 block input from the block divider 151, and the values of pixels of an 8×8 block at a point of a reference picture, at the same points.

SAD function values are measured with respect to all 8×8 blocks available in the reference picture, and an 8×8 block having a minimum SAD function value is detected. A motion vector shows a variation in location of an 8×8 block of a current picture with respect to that of the 8×8 block of the reference picture.

Alternatively, a measure function, other than the SAD function, may be used for motion estimation. For instance, a sum-of-absolute-transformed-difference (SATD) function or a sum-of-squared-difference (SSD) function may be used.

After step 212a, the reference picture/block mode determination unit 154 determines ones of the N reference pictures, which results in the highest accuracy of motion estimation, as reference pictures for the sub blocks B₁, B₂, B₃ and B₄ (step 212b).

The accuracy of motion estimation is determined by sizes of the SAD function values calculated using the respective reference pictures, based on a fact that the higher the similarity between the current picture and the reference picture, the smaller the SAD function value.

In steps 210 and 212, reference pictures, which will be used for motion estimation on the respective 8×8 blocks, are determined by performing motion estimation in the 8×8 block mode.

The reference picture/block mode determination unit 154 counts equivalent reference pictures, among the four reference pictures, which are determined with respect to the respective four blocks B₁, B₂, B₃, and B₄ in step 212 (step 214).

If it is determined in step 214 that the equivalent reference pictures total four, that is, when all the four sub blocks B₁, B₂, B₃, and B₄ use the equivalent four reference pictures, the reference pictures are finally determined as the reference pictures for motion estimation of the four blocks (step 215).

Upon determining the final reference pictures for the four sub blocks B₁, B₂, B₃, and B₄, block modes for the four sub blocks B₁, B₂, B₃, and B₄ are determined (step 216). One of 8×8, 8×4, 4×8, and 4×4 block modes is determined as a block mode of each of the four sub blocks B₁, B₂, B₃, and B₄, using various methods. For instance, motion estimation is performed on the respective sub blocks B₁, B₂, B₃, and B₄ in various sub block modes that are smaller than or equivalent to the 8×8 block mode, and then, one of the sub block modes, in which the highest encoding performance for motion estimation is obtained, is selected as the block mode.

If it is determined in step 214 that the number of equivalent reference pictures is one, that is, when all the four sub blocks B₁, B₂, B₃, and B₄ use different reference pictures, the reference pictures determined in step 212 are finally determined as the reference pictures used for motion estimation of the four blocks (step 218).

After step 218, a block mode of each of the four sub blocks B₁, B₂, B₃, and B₄ is determined similarly to step 216 (step 219). A method of determining a block mode of the four sub blocks B₁, B₂, B₃, and B₄ is not limited.

FIG. 6B is a flowchart illustrating a method of determining a reference picture and a block mode when there are two equivalent reference pictures.

If it is determined in step 214 that a number of sub blocks using the same reference picture is two, for example, when reference pictures used by the sub blocks B₁ and B₂ are the same (step 220), the reference picture/block mode determination unit 154 determines whether motion vectors MV(B₁) and MV(B₂) of the respective sub blocks B₁ and B₂ received from the motion estimator 153 are similar to each other (step 222). The motion vectors MV(B₁) and MV(B₂) are obtained using the reference pictures of the sub blocks B₁ and B₂ determined in step 212.

When the two 8×8 sub blocks B₁ and B₂ use the same reference picture and their motion vectors are similar to each other, the same motion vectors are expected to be obtained even when motion estimation is performed on a 16×8 block, which is obtained by grouping the sub blocks B₁ and B₂, using the same reference picture. Accordingly, an input macro block is determined to be a 16×8 block mode and motion estimation is performed in the 16×8 block mode.

In this embodiment, it is assumed that the sub blocks B₁ and B₂ use the same reference picture. However, motion estimation is performed in an 8×16 block mode, when the sub blocks B₁ and B₃, or the sub blocks B₂ and B₄ use equivalent reference pictures and the motion vectors MV(B₁) and MV(B₃) or the motion vectors MV(B₂) and MV(B₄) are similar to each other.

Whether two motion vectors are equivalent to each other may be determined using the difference between coordinate values of X-axes of the two motion vectors and the difference between coordinate values of Y-axes thereof. That is, when the differences fall within predetermined limit values, the two motion vectors are determined to be equivalent to each other.

If the motion vectors MV(B₁) and MV(B₂) are different from each other, a block mode of the input macro block is determined as an 8×8 block mode (step 242). In this case, the reference pictures determined in step 212 are finally determined as those for the sub blocks B₁, B₂, B₃, and B₄.

However, when the motion vectors MV(B₁) and MV(B₂) are equivalent to each other, the block divider 151 groups the sub blocks B₁ and B₂, and the sub blocks B₃ and B₄ into two respective 16×8 sub blocks B₂₁ and B₂₂ and provides the 16×8 sub blocks B₂₁ and B₂₂ to the motion estimator 153, in response to a control signal generated by the reference picture/block mode determination unit 154 (step 224).

After step 224, the reference picture/block mode determination unit 154 determines a reference picture RefPic(B₂₁) used for motion estimation for the sub block B₂₁, i.e., a combination of the sub blocks B₁ and B₂, to be a reference picture used by the sub blocks B₁ and B₂ (step 226).

Also, motion estimation is performed on the sub block B₂₂ using reference pictures RefPic(B₃) and RefPic(B₄) for the respective sub blocks B₃ and B₄ so as to determine a reference picture for the sub block B₂₂ (step 228).

After step 228, it is determined whether use of the reference picture RefPic(B₃) or reference picture RefPic(B₄) results in more precise motion estimation (step 230). Similarly to step 212b, SAD function values are used for the determination in step 228.

After step 230, a reference picture RefPic(B₂₂) for the sub block B₂₂ is determined to be equivalent to the reference picture RefPic(B₃) or RefPic(B₄) (step 232 or 234).

Next, the amount of data obtained by performing motion estimation in the 8×8 block mode in steps 210 and 212, and the amount of data obtained by performing motion estimation in the 16×8 block mode in steps 224 through 234 are calculated (step 236).

Next, the amounts of data are compared to each other (step 238). In the case that the amount of data obtained by motion estimation in the 16×8 block mode is less than that of data obtained by motion estimation in the 8×8 block mode, it can be understood that encoding efficiency in the 16×8 block mode is better than that in the 8×8 block mode, and therefore, the 16×8 block mode is finally selected (step 240).

However, when the amount of data obtained by motion estimation in the 16×8 block mode is more than that of data obtained by motion estimation in the 8×8 block mode, the 8×8 block mode is finally selected (step 242).

In this embodiment, the encoding efficiency is determined based on the amount of data obtained by performing motion estimation in respective block modes. For instance, the amount of data may be measured using one of the aforementioned SAD function, a SATD function, a SSD function, a mean-of-absolute-difference (MAD) function, or a Lagrange function.

Alternatively, the encoding efficiency may be determined based on a predetermined determination method in consideration of both the amount of data and image quality. That is, a method of determining the encoding efficiency is not limited to the above description, and further, those skilled in the art could have determined the encoding efficiency using various methods.

Meanwhile, this embodiment discloses that the sub blocks B₁ and B₂ use the same reference picture, but the method of FIGS. 6A and 6B can be applied when the sub blocks B₁ and B₃ or the sub blocks B₂ and B₄ use the same reference picture.

Although now shown in the drawings, when two adjacent blocks, e.g., the sub blocks B₁ and B₃, use the same reference picture and two adjacent blocks, e.g., the sub blocks B₂ and B₄, use different reference pictures, it is possible to skip steps 228 through 234.

Even if two sub blocks, e.g., the sub blocks B₁ and B₄, use the same reference picture, the 8×8 block mode is determined as a block mode for motion estimation on an input macro block without taking any steps when the two sub blocks B₁ and B₄ are not adjacent to each other.

FIGS. 6C and 6D are flowcharts illustrating a method of determining a reference picture and a block mode when a number of equivalent reference pictures is three, according to an embodiment of the present invention.

The methods of FIGS. 6C and 6D are basically almost the same as that of FIG. 6B performed when a number of equivalent reference pictures is two. That is, depending on whether the adjacent two blocks are similar to each other, adjacent two blocks are combined together to make a new block mode; motion estimation is performed in the new block mode; the result of motion estimation is compared with that of the motion estimation which has already been performed in the 8×8 block mode, and one of the new block mode and the 8×8 block mode, which leads to higher encoding efficiency, is determined as a final block mode.

Hereinafter, a method of determining a reference picture and a block mode with respect to three equivalent reference pictures will be described in detail.

If it is determined in step 214 that three equivalent reference pictures are present, e.g., when equivalent reference pictures are determined to be used by the sub blocks B₁, B₂, and B₃ (step 250), the reference picture/block mode determination unit 154 determines whether the motion vectors MV(B₁) and MV(B₂) of the sub blocks B₁ and B₂, which are received from the motion estimator 153, are similar to each other (step 252). Here, the motion vectors MV(B₁) and MV(B₂) are obtained using the reference pictures, for the respective sub blocks B₁ and B₂, which are determined in step 212.

Whether the motion vectors MV(B₁) and MV(B₂) are similar to each other may be determined using the difference between coordinate values of X-axes of the motion vectors MV(B₁) and MV(B₂) and the difference between coordinate values of Y-axes thereof. That is, when these differences fall within predetermined limit values, the two motion vectors are determined to be equivalent to each other.

If the motion vectors MV(B₁) and MV(B₂) are similar to each other, the block divider 151 groups the sub blocks B₁ and B₂ and the sub blocks B₃ and B₄ into two respective 16×8 sub blocks B₂₁ and B₂₂ and provides the sub blocks B₂₁ and B₂₂ to the motion estimator 153, in response to a control signal generated by the reference picture/block mode determination unit 154 (step 254).

The reference picture/block mode determination unit 154 determines the reference picture RefPic(B₂₁) for motion estimation on the sub block B₂₁, i.e., a combination of the sub blocks B₁ and B₂, as the same reference picture used by the sub blocks B₁ and B₂ (step 256).

Next, motion estimation is performed on the sub block B₂₂ to determine a reference picture for the sub block B₂₂ using reference pictures RefPic(B₃) and RefPic(B₄) of the respective sub blocks B₃ and B₄ (step 258).

After step 258, it is determined whether use of the reference picture RefPic(B₃) or the reference picture RefPic(B₄) results in more precise motion estimation (step 260). Similarly to step 212b, SAD function values are used for the determination in step 260.

According to the result of determination in step 260, the reference picture RefPic(B₂₂) is determined to be equivalent to the reference picture RefPic(B₃) or the Reference picture RefPic(B₄) (step 262 or 264).

Next, the amount of data obtained by performing motion estimation in the 8×8 block mode in steps 210 and 212 and that of data obtained by performing motion estimation in the 16×8 block mode in steps 254 through 264 are calculated (step 266).

Next, the amount of data obtained in steps 254 through 264 is compared with that of data obtained in steps 210 and 212 (step 268). If the amount of data obtained by motion estimation in the 16×8 block mode is less than that of data obtained by motion estimation in the 8×8 block mode, it is understood that encoding efficiency in the 16×8 block mode is better than that in the 8×8 block mode, and thus, the 16×8 block mode is determined as a final block mode (step 270).

On the contrary, if the amount of data obtained in the 16×8 block mode is more than that of data obtained in the 8×8 block mode, the 8×8 block mode is determined as a final block mode (step 272).

In this embodiment, the encoding efficiency is determined based on the amounts of data obtained in the respective block modes. The amount of data obtained may be measured using one of the aforementioned SAD function, the SATD function, the SSD function, the MAD function, or the Lagrange function.

If it is determined in step 252 that the motion vectors MV(B₁) and MV(B₂) are different from each other, steps shown in FIG. 6D are performed. The steps of FIG. 6D is almost the same as those of FIG. 6C except that the sub blocks B₁ and B₃, and the sub blocks B₂ and B₄ are grouped into two groups depending on whether the motion vectors MV(B₁) and MV(B₃) are equivalent to each other.

In other words, the reference picture/block mode determination unit 154 determines whether the motion vectors MV(B₁) and MV(B₃) for the sub blocks B₁ and B₃ received from the motion estimator 153 are equivalent to each other (step 280).

If the motion vectors MV(B₁) and MV(B₃) are similar to each other, the block divider 151 groups the sub blocks B₁ and B₃ and the sub blocks B₂ and B₄ into two 8×16 sub blocks B₃₁ and B₃₂. That is, the block divider 151 divides an input macro block into two 8×16 sub blocks B₃, and B₃₂ and provides them to the motion estimator 153, in response to a control signal generated by the reference picture/block mode determination unit 154 (step 282).

After step 282, the reference picture/block mode determination unit 154 determines a reference picture RefPic(B₃₁) for motion estimation on the sub block B₃₁, which is obtained by grouping the sub blocks B₁ and B₃, as a reference picture used by the sub blocks B₁ and B₃ (step 284).

Next, motion estimation is performed on the sub block B₃₂ to determine a reference picture therefor using the reference pictures RefPic(B₂) and RefPic(B₄) for the sub blocks B₂ and B₄ (step 286).

After step 286, it is determined whether use of the reference picture RefPic(B₂) or the reference picture RefPic(B₄) leads to more precise motion estimation (step 288).

Based on the result of step 288, the reference picture RefPic(B₃₂) is determined to be equivalent to the reference picture RefPic(B₂) or the reference picture RefPic(B₄) (step 290 or 292).

Next, the amount of data obtained by performing motion estimation in the 8×8 block mode in steps 210 and 212, and that of data obtained by performing motion estimation in the 8×16 block mode in steps 282 through 292 are calculated (step 294).

Next, the amount of data obtained in steps 210 and 212 is compared with that of data obtained in steps 282 through 292 (step 296). If the amount of data obtained in the 8×16 block mode is less than that of data obtained in the 8×8 block mode, it is understood that encoding efficiency in the 8×16 block mode is better than that in the 8×8 block mode, and thus, the 8×16 block mode is determined to be a final block mode (step 298).

On the contrary, when the amount of data obtained in the 8×16 block mode is more than that of data obtained in the 8×8 block mode, the 8×8 block mode is determined as a final block mode (step 299).

Also, in this embodiment, the sub blocks B₁, B₂, and B₃ use the same reference picture, but a reference picture and a block mode can also be determined using the same methods of FIGS. 6C and 6D when the sub blocks B₁, B₂, and B₄, or the sub block B₂, B₃, and B₄ use the same reference picture.

However, in steps 252 through 280, determination of the similarity between motion vectors of two sub blocks is applied to only adjacent two sub blocks. For instance, even if two sub blocks adjacent in the diagonal direction use the same reference picture, the similarity between their motion vectors is not determined.

Hereinafter, when a plurality of sub blocks use reference pictures and motion estimation is performed in a plurality of block modes, a method of determining a block mode, according to an embodiment of the present invention will be described.

FIG. 8 is a block diagram of an apparatus for determining a block mode, according to an embodiment of the present invention. The apparatus of FIG. 8 includes a block divider 155, a motion estimator 157, and a block mode determination unit 159.

The apparatus of FIG. 8 may be equal to the motion estimator 150 of FIG. 3 or be included in the motion estimator 150, and performs a method of determining a block mode according to the present invention. In particular, the apparatus of FIG. 8 performs a method of determining a block mode according to the present invention when only a reference picture or only one of a plurality of reference pictures provided is used for motion estimation.

The block divider 155 receives an input video data block, i.e., image data in macro block units, divides the macro block into predetermined numbers of sub blocks, e.g., the 8×8 sub blocks B₁, B₂, B₃, and B₄ shown in FIG. 5, and outputs the image data in sub block units.

The motion estimator 157 receives a reference picture, receives the 8×8 sub blocks from the block divider 155, and performs motion estimation on the 8×8 sub blocks using the reference picture.

The block mode determination unit 159 receives, from the motion estimator 157, data used to determine a block mode, performs a method of determining a block mode according to the present invention, and outputs motion data including the block mode and motion vectors for motion estimation.

A method of determining a block mode, according to the present invention, using an apparatus such as that shown in FIG. 8 will be described.

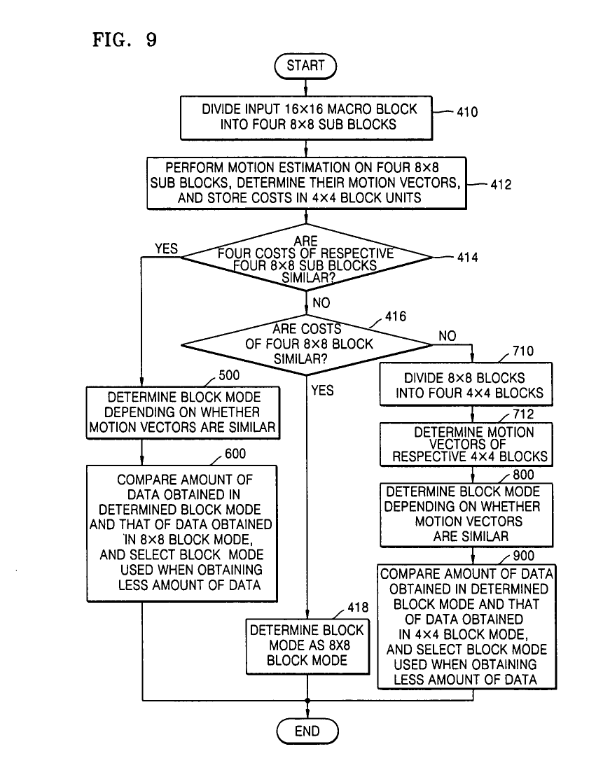

FIG. 9 is a flowchart illustrating a method of determining a block mode, according to an embodiment of the present invention.

Referring to FIG. 9, the block divider 155 divides an input macro block into four 8×8 sub blocks B₁, B₂, B₃, and B₄ as shown in FIG. 5 (step 410).

Next, the motion estimator 157 sequentially receives the four 8×8 sub blocks B₁, B₂, B₃, and B₄ from the block divider 155, determines their motion vectors by performing motion estimation on the respective 8×8 sub blocks using the input reference pictures, and stores costs in 4×4 block units (step 412). In this embodiment, motion estimation is performed using the aforementioned SAD function.

More specifically, SAD function values are calculated with respect to the respective sub blocks B₁, B₂, B₃, and B₄ with respect to every possible 8×8 sub blocks divided from the reference block. Next, an 8×8 sub block, of the reference picture, which has the minimum SAD function value is detected, and then, motion vectors MV(B₁), MV(B₂), MV(B₃), and MV(B₄) for B₁, B₂, B₃, and B₄ with respect to the detected 8×8 sub block are determined. The SAD function values are stored in 4×4 block units so that they can be used during a subsequent process. The SAD function values stored in the 4×4 block units are referred to as costs.

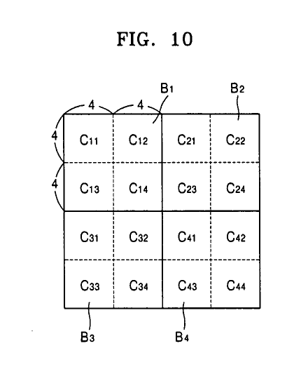

FIG. 10 illustrates SAD function values that are calculated to determine motion vectors for respective sub blocks B₁, B₂, B₃, and B₄ and stored in 4×4 block units.

For instance, in the case of the sub block B₁, SAD function values are calculated in 4×4 sub block units, stored as C₁₁, C₁₂, C₁₃, and C₁₄, and combined to obtain a SAD function value. That is, the SAD function value of the sub block B₁ is a sum of the values C₁₁, C₁₂, C₁₃, and C₁₄.

Alternatively, a function, other than the SAD function, may be used as a measure function for motion estimation. For instance, the SATD function or the SSD function may be used.

In above steps 410 and 412, motion estimation is first performed in the 8×8 block mode among a plurality of block modes. After step 412, a final block mode is determined based on result of motion estimation performed in the 8×8 block mode.

Next, the block mode determination unit 159 determines the similarity among SAD function values, of the respective four sub blocks B₁, B₂, B₃, and B₄, which are stored in the 4×4 block units (step 414).

In step 412, it is determined whether there is a need to perform motion estimation on a basis of blocks that are smaller than the 8×8 blocks. For the determination, SAD function values, which are referred to as cost, stored during motion estimation in step 412, are used. For instance, when one of the four SAD function values C₁₁, C₁₂, C₁₃, and C₁₄ of the sub block B₁ is fairly smaller than the other three SAD function values, the result of motion estimation performed in the 8×8 block mode is considered as incorrect. Therefore, motion estimation is performed in a block mode, which is smaller than the 8×8 block mode, so as to obtain more precise motion estimation.

The similarity between two SAD function values may be determined, for example, by checking whether the difference between the two SAD function values falls within a predetermined limit value.

If it is determined in step 414 that the SAD function values C₁₁, C₁₂, C₁₃, and C₁₄ of the sub block B₁ are similar, SAD function values C₂₁, C₂₂, C₂₃, and C₂₄ of the sub block B₂ are similar, SAD function values C₃₁, C₃₂, C₃₃, and C₃₄ of the sub block B₃ are similar, and SAD function values C₄₁, C₄₂, C₄₃, and C₄₄ of the sub block B₄ are also similar, then in this case, a block mode is determined depending on whether the motion vectors MV(B), MV(B₂), MV(B₃), and MV(B₄), of the sub blocks B₁, B₂, B₃, and B₄, determined in step 412, are similar (step 500).

If it is determined in step 414 that there is no need to perform motion estimation in a block mode which is smaller than the 8×8 block mode, whether a block mode, which is larger than the 8×8 block mode, can be set as a final block mode is determined based on the similarity among the motion vectors MV(B₁), MV(B₂), MV(B₃), and MV(B₄) in step 500.

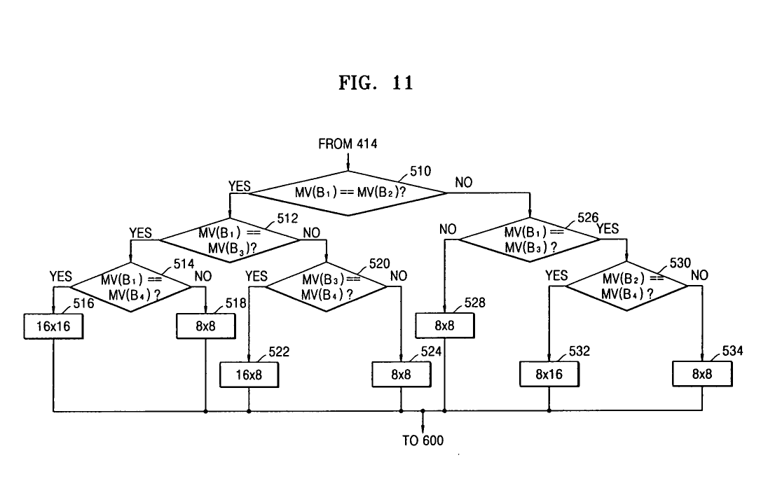

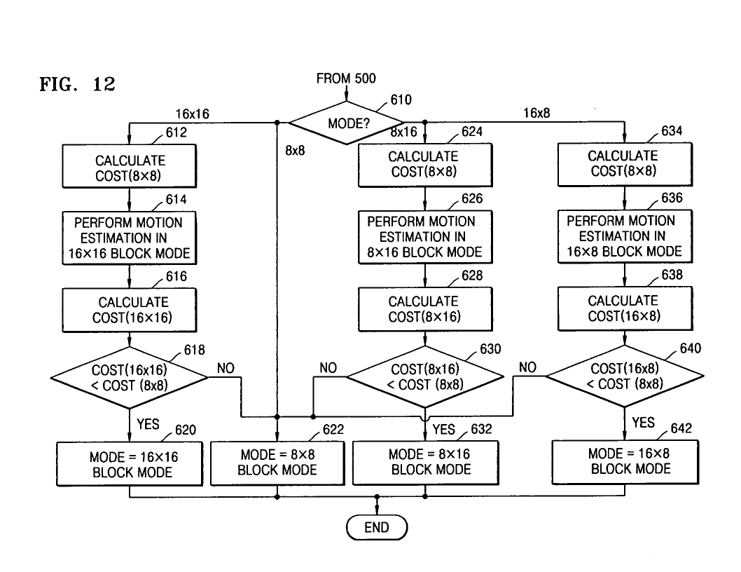

FIG. 11 is a detailed flowchart illustrating step 500 of FIG. 9. Referring to FIG. 11, the similarity among the four motion vectors MV(B₁), MV(B₂), MV(B₃), and MV(B₄) is determined (steps 510 through 514, 520, 526, and 530). If all the motion vectors MV(B1) through MV(B4) are similar, the 16×16 block mode is determined as a final block mode (step 516).

If the motion vectors MV(B1) and MV(B2) are similar and the motion vectors MV(B3) and MV(B4) are similar, a 16×8 block mode is chosen as a final block mode (step 522). If the motion vectors MV(B1) and MV(B3) are similar and the motion vectors MV(B2) and MV(B4) are similar, an 8×16 block mode is chosen as a final block mode (step 532).

However, there are cases where no pairs of adjacent blocks having similar motion vectors are present, or motion vectors of a pair of adjacent first sub blocks are similar but motion vectors of another pair of adjacent to first sub blocks are not similar. In this case, the 8×8 block mode is chosen as a final block mode (steps 518, 524, 528, and 534).

In FIG. 11, “==” denotes that two motion vectors are similar rather than are the same.

Next, the amount of data obtained in a block mode determined in step 500 is compared with that of data obtained in the 8×8 block mode in steps 410 and 412, and the block mode where less amount of data is obtained is determined a final block mode (step 600).

FIG. 12 is a detailed flowchart illustrating step 600 of FIG. 9. Referring to FIG. 9, the type of block mode determined in step 500 is checked (step 610).

If the determined block mode is the 16×16 block mode, a cost cost (8×8) in the 8×8 block mode is calculated (step 612). Here, the cost cost (8×8) denotes a sum of the SAD function values computed in step 412 where the motion vectors for the sub blocks B₁, B₂, B₃, and B₄ are obtained. The sum of the SAD function values is used as a reference value allowing estimation of the amount of data to be encoded or transmitted when motion estimation is performed on a predetermined block basis.

The block mode determination unit 159 outputs a control signal to the block divider 155. Then, the block divider 155 receives the control signal and provides the input macro block to the motion estimator 157 without dividing the macro block into sub blocks. The motion estimator 157 performs motion estimation on the input macro block on a 16×16 block basis using a predetermined reference picture (step 614).

Next, during the motion estimation in step 614, the motion estimator 157 computes cost cost(16×16) (step 616).

Next, the block mode determination unit 159 receives the costs cost(8×8) and cost(16×16) from the motion estimator 157 and compares them (step 618).

If it is determined in step 630 that the cost cost(16×16) is smaller than the cost cost(8×8), a block mode for motion estimation on the input macro block is finally determined as the 16×16 block mode (step 620).

In contrast, if it is determined in step 630 that the cost cost(8×8) is smaller than the cost cost(16×16), a block mode for motion estimation on the input macro block is finally determined as the 8×8 block mode (step 622).

When it is determined in step 610 that the type of block mode chosen in step 500 is the 8×8 block mode, the block mode for motion estimation on the input macro block is determined as the 8×8 block mode without taking further steps (step 622).

When it is determined in step 610 that the type of block mode chosen in step 500 is the 8×16 block mode, a cost cost(8×8) in the 8×8 block mode is computed (step 624).

After step 624, the block mode determination unit 159 outputs the control signal to the block divider 155, and then, the block divider 155 divides the input macro block into two 8×16 sub blocks and provides them to the motion estimator 157 in response to the control signal. Next, the motion estimator 157 performs motion estimation on the received two 8×16 sub blocks on an 8×16 block basis using a predetermined reference picture (step 626).

After step 626, the motion estimator 157 computes a cost cost(8×16) (step 628). Here, the cost cost(8×16) for the input macro block is obtained by combining respective costs cost(8×16) calculated during the motion estimation on the two 8×16 sub blocks.

Next, the block mode determination unit 159 receives the costs cost(8×8) and cost(8×16) from the motion estimator 157 and compares them (step 630).

If the cost cost(8×16) is smaller than the cost cost(8×8), a block mode for motion estimation on the input macro block is finally determined as the 8×16 block mode (step 632).

If the cost cost(8×8) is smaller than the cost cost(8×16), a block mode for motion estimation on the input macro block is finally determined as the 8×8 block mode (step 622).

When it is determined in step 610 that the type of block mode chosen in step 500 is the 16×8 block mode, a cost cost(8×8) in the 8×8 block mode is computed (step 634).

Next, the block mode determination unit 159 outputs the control signal to the block divider 155, and the block divider 155 divides the input macro block into two 16×8 sub blocks and provides them to the motion estimator 157 in response to the control signal. Then, the motion estimator 157 performs motion estimation on the received two 16×8 blocks on a 16×8 block basis using a predetermined reference picture (step 636).

Next, the motion estimator 157 computes a cost cost(16×8) (step 638). Here, the cost cost(16×8) for the input macro block is obtained by combining the respective costs cost(16×8) calculated during motion estimation on the two 16×8 sub blocks.

Next, the block mode determination unit 159 receives the costs cost(8×8) and cost(16×8) from the motion estimator 157 and compares them (step 640).

If it is determined in step 640 that the cost cost(16×8) is smaller than the cost cost(8×8), a block mode for motion estimation on the input macro block is finally determined as the 16×8 block mode (step 642).

If the cost cost(8×8) is smaller than the cost cost(16×8), a block mode for motion estimation on the input macro block is finally determined as the 8×8 block mode (step 622).

Meanwhile, in this embodiment, a final block mode is determined depending on the amount of data using the SAD function value as a cost. However, the amount of data is just a criterion for determining encoding efficiency of motion estimation in the respective block modes. For the determination of the encoding efficiency, various criteria, for example, image quality, may further be used. In other words, various methods are applicable when determining a block mode for obtaining higher encoding efficiency and those skilled in the art could have easily adopted various criteria for determining the encoding efficiency.

Also, in this embodiment, a value of a SAD function is used as a criterion for determining the amount of data obtained, but one of other types of functions such as a SATD function, a SSD function, a MAD function, or a Lagrange function, may be used.

If it is determined in step 414 that all SAD function values, of even one of the four 8×8 sub blocks B₁, B₂, B₃, and B₄, which are stored in 4×4 block units are not similar, step 416 is performed.

More specifically, the block mode determination unit 159 receives from the motion estimator 157 the four SAD function values, of the respective four sub blocks B₁, B₂, B₃, and B₄, which are stored in 4×4 block units, and determines on an 8×8 block basis whether all four SAD function values in 4×4 block units are similar (step 416).

When all four SAD function values in 4×4 block units are similar, a block mode for motion estimation on the input macro block is determined as the 8×8 block mode without taking further steps (step 418).

However, when all four SAD function values, of the sub block B₁, in 4×4 block units are not similar, the block mode determination unit 159 outputs the control signal to the block divider 155, and the block divider 155 divides the sub block B₁ into four 4×4 sub blocks b₁, b₂, b₃, and b₄ so as to perform motion estimation on a 4×4 block basis, in response to the control signal (step 710).

Next, the motion estimator 157 receives the four 4×4 sub blocks b₁, b₂, b₃, and b₄ of the sub block B₁ from the block divider 155, performs motion estimation on these blocks, and determines their motion vectors MV(b₁), MV(b₂), MV(b₃), and MV(b₄) (step 712).

Next, a block mode is determined depending on similarity among the motion vectors MV(b₁), MV(b₂), MV(b₃), and MV(b₄) (step 800).

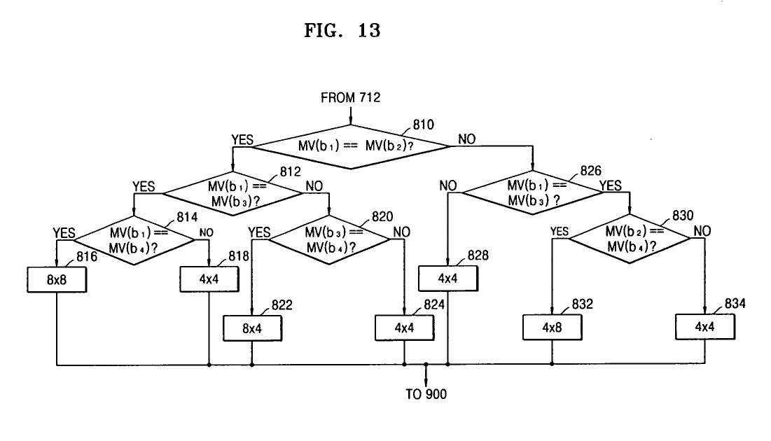

FIG. 13 is a detailed flowchart illustrating step 800 of FIG. 9. Referring to FIG. 13, when all four motion vectors MV(b₁), MV(b₂), MV(b₃), and MV(b₄) are similar, the block mode is determined as the 8×8 block mode (step 816).

However, if the motion vectors MV(b1) and MV(b2) are similar and the motion vectors MV(b3) and MV(b4) are similar, the block mode is determined as the 8×4 block mode (step 822). If the motion vectors MV(b1) and MV(b3) are similar and the motion vectors MV(b2) and MV(b4) are similar, the block mode is determined as the 4×8 block mode (step 832).

However, there are cases where no adjacent blocks whose motion vectors are similar are present, or where a pair of adjacent first sub blocks are not similar although motion vectors of the other pair of adjacent first sub blocks are similar. In these cases, the block mode is determined as the 4×4 block mode (steps 818, 824, 828, and 834).

Next, the amount of data obtained in the block mode, determined with respect to the sub block B₁ in step 800, is compared with that of data obtained in the 4×4 block mode, determined with respect to the sub block B₁ in steps 710 and 712, and then, the block mode in which less amount of data is obtained is selected as a final block mode of the sub block B₁ (step 900).

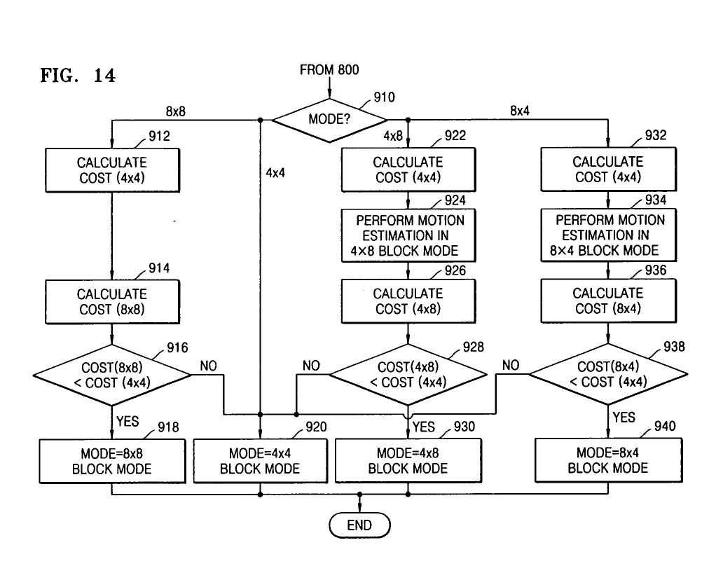

FIG. 14 is a detailed flowchart illustrating step 900 of FIG. 9. Referring to FIG. 14, the block mode determined with respect to the sub block B₁ in step 800 is checked (step 910).

If the determined block mode is the 8×8 block mode, a cost cost(4×4) for the sub block B, in the 4×4 block mode is calculated (step 912). The cost cost(4×4) is calculated by combining the four SAD function values obtained by motion estimation on the sub blocks b₁, b₂, b₃, and b₄ of the sub block B₁ in step 712.

After step 912, a cost cost (8×8) for the sub block B, in the 8×8 block mode is computed (step 914). The cost cost(8×8) is obtained using the SAD function value calculated to obtain the motion vector of the sub block B, in step 412.

Next, the block mode determination unit 159 receives the costs cost(8×8) and cost(4×4) from the motion estimator 157 and compares them (step 916).

If the cost cost(8×8) is smaller than the cost cost(4×4), a block mode for motion estimation on the sub block B₁ is finally determined as the 8×8 block mode (step 918).

However, if the cost cost(4×4) is smaller than the cost cost(8×8), a block mode for motion estimation on the sub block B₁ is finally determined as the 4×4 block mode (step 920).

When the block mode determined in step 910 is the 4×4 block mode, a block mode for motion estimation on the sub block B₁ is finally determined as the 4×4 block mode without performing any additional processes (step 920).

When the block mode determined in step 910 is the 4×8 block mode, a cost cost(4×4) for the sub block B₁ in the 4×4 block mode is calculated similarly to step 912 (step 922).

After step 922, the block mode determination unit 159 outputs the control signal to the block divider 155, and the block divider 155 divides the sub block B₁ into two 4×8 sub blocks and provides them to the motion estimator 157 in response to the control signal. Then, the motion estimator 157 performs motion estimation on the received two 4×8 sub blocks on a 4×8 block basis using a predetermined reference picture (step 924).

The motion estimator 157 calculates a cost cost(4×8) for the sub block B₁ (step 926). The cost cost(4×8) for the sub block B₁ is obtained by combining costs cost(4×8) calculated by motion estimation on the two 4×8 sub blocks.

Next, the block mode determination unit 159 receives the costs cost(4×4) and cost(4×8) from the motion estimator 157 and compares them (step 928).

If the cost cost(4×8) is smaller than the cost cost(4×4), a block mode for motion estimation on the sub block B, is finally determined as the 4×8 block mode (step 930).

However, if the cost cost(4×4) is smaller than the cost cost(4×8), a block mode for motion estimation on the sub block B₁ is finally determined as the 4×4 block mode (step 920).

If the block mode determined in step 910 is the 8×4 block mode, a cost cost(4×4) for the sub block B, in the 4×4 block mode is calculated similarly to step 912 (step 932).

Next, the block mode determination unit 159 outputs the control signal to the block divider 155, and the block divider 155 divides the sub block B₁ into two 8×4 sub blocks and provides them to the motion estimator 157 in response to the control signal. The motion estimator 157 performs motion estimation on the received two 8×4 sub blocks on an 8×4 block basis using a predetermined reference picture (step 934).

The motion estimator 157 calculates a cost cost(8×4) for the sub block B₁ (step 936). In this case, the cost cost(8×4) for the sub block B₁ is obtained by combining the costs cost(8×4) calculated by motion estimation on the respective two 8×4 sub blocks.

Next, the block mode determination unit 159 receives the costs cost(4×4) and cost(8×4) from the motion estimator 157 and compares them (step 938).

If the cost cost(8×4) is smaller than the cost cost(8×4), a block mode for motion estimation on the sub block B₁ is finally determined as the 8×4 block mode (step 940).

However, when the cost cost(4×4) is smaller than cost cost(8×4), a block mode for motion estimation on the sub block B₁ is finally determined as the 4×4 block mode (step 920).

The present invention can be embodied as a computer readable code in a computer readable medium. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable recording medium can be distributed among computer systems that are interconnected through a network, and the present invention may be stored and implemented as a computer readable code in the distributed system.

As described above, when motion estimation is conventionally performed in various block modes using a plurality of reference pictures, motion estimation must be repeatedly performed on an input macro block with respect to the respective reference pictures and in the respective block modes. Next, a reference picture and a block mode, which lead to the highest encoding efficiency, are determined. Then, inter prediction coding is performed on the input macro block using the determined reference picture in the determined block mode. Accordingly, the above conventional method requires very large amount of calculation, thus weighing down an encoder.

To solve this problem, use of a method and apparatus for determining a reference picture for high-speed motion estimation, according to the present invention, remarkably reduces a number of times of performing motion estimation by using the result of motion estimation performed in one block mode. Accordingly, a reference picture and a block mode, or a block mode (when determination of a reference picture is not required) can be determined with less calculation.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of determining a reference picture and a block mode, the method comprising:
(a) dividing a video data block of a predetermined size into 2M first sub blocks, wherein M is an integer that equals or is larger than 1;
(b) selecting reference pictures for motion estimation on the respective 2M first sub blocks from N reference pictures, wherein N is an integer that equals or is larger than 2;
(c) counting a number of the first sub blocks that use the same reference picture;
(d) determining whether there are two adjacent first sub blocks using the same reference picture when a number of the first sub blocks using the same reference picture is two or more and is (2M−1) or less; and
(e) when there are two adjacent first sub blocks using the same reference picture, determining a reference picture and a block mode depending on whether two motion vectors are similar, the two motion vectors obtained by performing motion estimation on the two respective adjacent first sub blocks.

2. The method of claim 1, wherein when the two motion vectors are similar, (e) comprises:
(e1) dividing the video data block into M second sub blocks by grouping the two adjacent first sub blocks and grouping the other (2M−2) first sub blocks into groups of two in the direction in which the two adjacent first sub blocks are adjacent to each other;
(e2) determining a reference picture, which is used by the second sub blocks grouped from the two adjacent first sub blocks, as the same reference picture used in (c); and
(e3) performing motion estimation on the second sub blocks using the reference picture determined in (e2).

3. The method of claim 2, wherein when all the first sub blocks, other than the two adjacent first sub blocks, use different reference pictures, (e) comprises:
(e4) performing motion estimation on respective (M−1) second sub blocks, which are grouped by dividing the first sub blocks, other than the two adjacent first sub blocks, into groups of two, using the different reference pictures; and
(e5) evaluating accuracy of the results of motion estimation performed on the respective (M−1) second sub blocks, and determining a reference picture, which is used when obtaining a highest accuracy of the results of motion estimation, as a reference picture for the (M−1) second sub blocks.

4. The method of claim 3, wherein (e) further comprises (e6) comparing an amount of data obtained when performing motion estimation on the video data block in a mode of the second sub blocks using the chosen reference pictures and an amount of data obtained when performing motion estimation on the video data block in a mode of the first sub blocks using the determined reference picture; and determining the mode of the first or second sub blocks used when obtaining a lesser amount of data as a block mode of the video data block.

5. The method of claim 1, wherein with respect to (e), when the two motion vectors are not similar, the mode of the first sub blocks is determined as a block mode of the video data block.

6. The method of claim 1, where with respect to (e), the two motion vectors are determined to be similar when the difference between coordinate values of the X-axes of the two motion vectors and the difference between coordinate values of the Y-axes of the two motion vectors fall within ranges of respective predetermined limit values.

7. The method of claim 1, wherein the video data block is a 16×16 pixel macro block, the first sub blocks are 8×8 pixel sub blocks and the second sub blocks are 16×8 or 8×16 pixel sub blocks.

8. The method of claim 3, wherein with respect to (e5), the accuracy of the results of motion estimation are determined using values of a sum-of-absolute-difference (SAD) function which are sums of the differences between values of pixels of the second sub blocks of the video data block and corresponding values of pixels of second sub blocks of the reference picture which correspond to the second sub blocks of the video data block.

9. The method of claim 1, wherein (b) comprises:
(b1) performing motion estimation on the respective first sub blocks N times using the N reference pictures; and
(b2) evaluating accuracy of the results of motion estimation performed on the respective first sub blocks N times, and determining a reference picture, which is used when obtaining a highest accuracy of the results of motion estimation, as a reference picture for the first sub blocks.

10. The method of claim 1, wherein when it is determined in (c) that all the 2M first sub blocks use the same reference picture, further comprising (f) determining a reference picture used by all the first sub blocks as a reference picture used to perform motion estimation on the video data block in a predetermined block mode.

11. The method of claim 1, wherein when it is determined in (c) that all the 2M first sub blocks use different reference pictures, further comprising (g) determining the different reference pictures used by all the first sub blocks as reference pictures used to perform motion estimation on the respective first sub blocks in a predetermined block mode.

12. An apparatus for determining a reference picture and a block mode, the apparatus comprising:
a block divider that divides an input video data block of a predetermined size into 2M first sub blocks, wherein M is an integer that equals or is larger than 1;
a motion estimator that receives N reference pictures, receives the 2M first sub blocks from the block divider, and performs motion estimation on the respective first sub blocks using the N reference pictures, wherein N is an integer that equals or is larger than 2; and
a reference picture and block mode determination unit that determines a reference picture, which is used when obtaining a highest accuracy of a result of motion estimation received from the motion estimator, as a reference picture for the first sub blocks using the N reference pictures, and N reference values that indicate accuracy of the result of motion estimation performed on the respective first sub blocks N times, and
receives, from the motion estimator, two motion vectors obtained by performing motion estimation on two adjacent first sub blocks using the same reference picture and determines a reference picture and a block mode depending on whether the two motion vectors are similar, when a number of the first sub blocks using the same reference picture is two or more and (2M−1) or less and two adjacent first sub blocks using the same reference picture are present.

13. The apparatus of claim 12, wherein when the two motion vectors are similar, the reference picture and block mode determination unit determines a reference picture for second sub blocks, which are grouped from the two adjacent first sub blocks, as the same reference picture,
the block divider receives a command of grouping the two adjacent first sub blocks from the reference picture and block mode determination unit, divides the video data block into M second sub blocks by grouping the two adjacent first sub blocks and dividing the other (2M−2) first sub blocks in the direction of the two adjacent first sub blocks into groups of two, and provides the obtained M second sub blocks to the motion estimator, and
the motion estimator receives an index indicating the determined reference picture from the reference picture and block mode determination unit, and performs motion estimation on the second sub blocks, which are grouped from the two adjacent first sub blocks, using a reference picture indicated in the index.

14. The apparatus of claim 13, wherein when all the first sub blocks other than the two adjacent first sub blocks use different reference pictures, the reference picture and block mode determination unit receives, from the motion estimator, a plurality of reference values representative of the accuracy of the result of motion estimation performed on respective (M−1) second sub blocks, which are divided from the first sub blocks other than the two adjacent first sub blocks into groups of two, using the different reference pictures, and
determines a reference picture, which is used when obtaining the highest accuracy of the result of motion estimation using the plurality of reference values, as a reference picture for the (M−1) second sub blocks.

15. The apparatus of claim 14, wherein the reference picture and block mode determination unit compares the amount of data obtained by performing motion estimation on the video data block in a mode of the second sub blocks using the determined reference picture and the amount of data obtained by performing motion estimation on the video data block in a mode of the first sub blocks using the determined reference picture, and
determines the mode of the first or second sub blocks used when obtaining a lesser amount of data as a block mode of the video data block.

16. The apparatus of claim 12, wherein the reference picture and block mode determination unit determines the mode of the first sub blocks as a block mode of the video data block when the two motion vectors are not similar.

17. The apparatus of claim 12, wherein the reference picture and block mode determination unit determines that the two motion vectors are similar when the difference between coordinate values of the X-axes of the two motion vectors and the difference between coordinate values of the Y-axes of the two motion vectors fall within ranges of predetermined limit values.

18. The apparatus of claim 12, wherein the video data block is a 16×16 pixel macro block, the first sub blocks are 8×8 pixel sub blocks, and the second sub blocks are 16×8 or 8×16 pixel sub blocks.

19. The apparatus of claim 12, wherein the reference values representative of the accuracy of the results of motion estimation are sum-of-absolute-difference (SAD) values that are sums of the differences between values of pixels of the first sub blocks of the video data block and corresponding values of pixels of first sub blocks of the reference picture which correspond to the first sub blocks of the video data block, respectively.

20. A method of determining a block mode, comprising:
(a) performing motion estimation on an input video data block in a mode of first sub blocks thereof using a predetermined reference picture and a predetermined measure function for motion estimation, and obtaining values of the measure function and motion vectors for the respective first sub blocks;
(b) determining whether there is a need to perform motion estimation on the video data block in a mode of second sub blocks thereof which are smaller than the mode of the first sub blocks; and
(c) when there is no need to perform motion estimation on the video data block in the mode of the second sub blocks, determining a block mode of the video data block depending on whether motion vectors of the first sub blocks are similar.

21. The method of claim 20, wherein (a) comprises:
(a1) dividing the respective first sub blocks into a plurality of second sub blocks and computing values of a measure function with respect to the respective first sub blocks in units of the second sub blocks divided from the respective first sub blocks; and
(a2) obtaining the values of the measure function of the respective first sub blocks by combining the values of a measure function obtained in (a1).

22. The method of claim 21, wherein (b) comprises:
(b1) determining whether the values of the measure function of the respective first sub blocks are similar; and
(b2) determining that there is no need to perform motion estimation on the video data block in the mode of the second sub blocks when it is determined in (b1) that all the values of the measure function of the respective first sub blocks are similar.

23. The method of claim 20, wherein with respect to (c), a block mode is determined so that that motion estimation is performed in a unit of the video data block when all the motion vectors of the respective first sub blocks of the video data block are similar.

24. The method of claim 20, wherein the video data block is a 16×16 pixel macro block that is divided into four first 8×8 pixel sub blocks including a leftmost 8×8 pixel sub block and other 8×8 pixel sub blocks located clockwise from the leftmost pixel sub block, and first through fourth motion vectors correspond to the four first sub blocks,
wherein with respect to (c), a block mode for the video data block is determined as a 1 6×16 block mode when all of the first through fourth motion vectors are similar.

25. The method of claim 24, wherein with respect to (c), the block mode for the video data block is determined as a 16×8 block mode when the first and second motion vectors are similar and the third and fourth motion vectors are similar.

26. The method of claim 24, wherein with respect to (c), the block mode for the video data block is determined as an 8×16 block mode when the first and third motion vectors are similar and the second and fourth motion vectors are similar.

27. The method of claim 24, wherein with respect to (c), the block mode for the video data block is determined as an 8×8 block mode, when a pair of adjacent first sub blocks whose motion vectors are similar is not present, or when motion vectors of a pair of adjacent first sub blocks are not similar although motion vectors of the other pair of adjacent first sub blocks are similar.

28. The method of claim 20, further comprising (d) comparing the amount of data obtained by performing motion estimation on the video data block in the determined block mode and the amount of data obtained when performing motion estimation on the video data block in a mode of the first sub blocks, and
determining a block mode, which is used when obtaining a lesser amount of data, as a block mode of the video data block.

29. The method of claim 20, wherein with respect to (c), the two motion vectors are determined to be similar when the difference between coordinate values of the X-axes of the two motion vectors and the difference between coordinate values of the Y-axes of the two motion vectors fall within ranges of respective predetermined limit values.

30. The method of claim 20, wherein with respect to (a), the motion vectors are determined using a sum-of-absolute-difference (SAD) function, a sum-of-absolute-transformed-difference (SATD) function, or a sum-of-squared-difference (SSD) function.

31. The method of claim 28, wherein with respect to (d), the amounts of data, which are obtained in the respective block modes, are measured using one of a sum-of-absolute-difference (SAD) function, a sum-of-absolute-transformed-difference (SATD) function, a sum-of-squared-difference (SSD) function, or mean-of-absolute-difference (MAD) function, or a Lagrange function.

32. The method of claim 22, wherein with respect to (b2), when the difference between values of two measure functions falls within a range of a predetermined limit value, the values of the two measure functions are determined to be similar.

33. The method of claim 22, wherein when it is determined in (b1) that there is a first sub block Bₖ having at least one value of measure function that is not similar to the other values of measure function, wherein k is an integer from 1 to 4, the method further comprising:
(e) determining motion vectors of the respective second sub blocks by performing motion estimation on the first sub block Bₖ in the mode of the second sub blocks, using the predetermined reference picture and measure function; and
(f) determining a block mode for the video data block by determining whether motion vectors of a plurality of second sub blocks of the first sub block Bₖ are similar.

34. The method of claim 33, wherein the video data block is a 16×16 pixel macro block divided into four first 8×8 pixel sub blocks including a leftmost 8×8 pixel sub block and other 8×8 pixel sub blocks located clockwise from the leftmost 8×8 pixel sub block, and
the first sub block Bₖ is divided into four second 4×4 pixel sub blocks including a leftmost 4×4 pixel sub block and other 4×4 pixel sub blocks located clockwise from the leftmost 4×4 pixel sub block, and
first through fourth motion vectors correspond to the four sub blocks,
wherein with respect to (f), a block mode for the video data block is determined as an 8×8 block mode when all of the first through fourth motion vectors are similar.

35. The method of claim 33, wherein with respect to (f), a block mode for the first sub block Bₖ is determined as an 8×4 block mode when the first and second motion vectors are similar and the third and fourth motion vectors are similar.

36. The method of claim 33, wherein with respect to (f), a block mode for the first sub block Bₖ is determined as a 4×8 block mode when the first and third motion vectors are similar and the second and fourth motion vectors are similar.

37. The method of claim 33, wherein with respect to (f), a block mode for the first sub block Bₖ is determined as a 4×4 block mode, when a pair of adjacent second sub blocks whose motion vectors are similar is not present, or when motion vectors of a pair of adjacent second sub blocks are not similar although motion vectors of the other pair of adjacent second sub blocks are similar.

38. The method of claim 33, further comprising (g) comparing the amount of data obtained by performing motion estimation on the first sub block Bₖ in the block mode determined in (f) and the amount of data obtained by performing motion estimation on the first sub block Bₖ in the mode of the second sub blocks, and
determining a block mode, which is used when obtaining a lesser amount of data, as a block mode of the first sub block Bₖ.

39. An apparatus for determining a reference picture and a block mode, the apparatus comprising:
a block divider that divides a video data block into a plurality of first sub blocks;
a motion estimator that determines values of a measure function and motion vectors of the respective first sub blocks by receiving N predetermined reference pictures, receiving the plurality of first sub blocks from the block divider, and performing motion estimation on the video data block in a mode of the first sub blocks using the N reference pictures and a predetermined measure function for motion estimation; and
a block mode determination unit that determines a block mode depending on whether motion vectors of the respective first sub blocks are similar, when it is determined that there is no need to perform motion estimation on the video data block in a mode of second sub blocks that is smaller than the mode of the first sub blocks, using a plurality of values of measure function calculated by performing motion estimation on the first sub blocks received from the motion estimator.

40. The method of claim 39, wherein the block mode determination unit receives a plurality of values of the measure function which are calculated in units of second sub blocks of the respective sub blocks and input from the motion estimator, and repeatedly determines whether the values of the measure function are similar with respect to the respective first sub blocks, and
determines that there is no need to perform motion estimation on the first sub blocks in the mode of the second sub blocks when all the values of the measure function are similar.

41. The apparatus of claim 39, wherein the block mode determination unit determines a block mode so that motion estimation is performed in a unit of the video data block when all motion vectors of the plurality of respective first sub blocks of the video data block are similar.

42. The apparatus of claim 39, wherein the video data block is a 16×16 pixel macro block that is divided into four first 8×8 pixel sub blocks including a leftmost 8×8 pixel sub block and other 8×8 pixel sub blocks located clockwise from the leftmost 8×8 pixel sub block, and first through fourth motion vectors correspond to the four first 8×8 pixel sub blocks,
wherein the block mode determination unit determines a block mode for the video data block as a 16×16 block mode when all of the first through fourth motion vectors are similar.

43. The apparatus of claim 42, wherein the block mode determination unit determines a block mode for the video data block is determined as a 16×8 block mode when the first and second motion vectors are similar and the third and fourth motion vectors are similar.

44. The apparatus of claim 42, wherein the block mode determination unit determines a block mode for the video data block as an 8×16 block mode when the first and third motion vectors are similar and the second and fourth motion vectors are similar.

45. The apparatus of claim 42, wherein the block mode determination unit determines a block mode for the video data block as an 8×8 block mode, when a pair of adjacent first sub blocks whose motion vectors are similar is not present, or when motion vectors of a pair of adjacent first sub blocks are not similar although motion vectors of the other pair of adjacent first sub blocks are similar.

46. The apparatus of claim 39, wherein the block mode determination unit compares the amount of data obtained by performing motion estimation on the video data block in the determined block mode and the amount of data obtained when performing motion estimation on the video data block in a mode of the first sub blocks, and determines a block mode, which is used when obtaining a lesser amount of data, as a block mode of the video data block.

47. The apparatus of claim 39, wherein the block mode determination unit determines that the two motion vectors are similar when the difference between coordinate values of the X-axes of the two motion vectors and the difference between coordinate values of the Y-axes of the two motion vectors fall within ranges of respective predetermined limit values.

48. The apparatus of claim 39, wherein the motion estimator determines the motion vectors using one of a sum-of-absolute-difference (SAD) function, a sum-of-absolute-transformed-difference (SATD) function, and a sum-of-squared-difference (SSD) function.

49. The apparatus of claim 46, wherein the block mode determination unit measures the amounts of data, which are obtained in the respective block modes, using one of a sum-of-absolute-difference (SAD) function, a sum-of-absolute-transformed-difference (SATD) function, a sum-of-squared-difference (SSD) function, and mean-of-absolute-difference (MAD) function, or a Lagrange function.

50. The apparatus of claim 40, wherein the block mode determination unit determines that values of two measure functions are similar when the difference between the values of the two measure functions falls within a range of a predetermined limit value.

51. The apparatus of claim 39, wherein when there is a first sub block Bₖ having at least one value of measure function that is not similar to the other values of measure function, the block mode determination unit outputs a control signal to the block divider and the block divider divides the first sub block Bₖ into a plurality of second sub blocks in response to the control signal, wherein k is an integer from 1 to 4,
the motion estimator determines motion vectors of the respective second sub blocks by performing motion estimation on the first sub block Bₖ in the mode of the second sub blocks, using the predetermined reference picture and measure function, and
the block mode determination unit determines a block mode for the video data block by determining whether motion vectors of a plurality of second sub blocks of the first sub block Bₖ are similar.

52. The apparatus of claim 51, wherein the video data block is a 16×16 pixel macro block divided into four first 8×8 pixel sub blocks including a leftmost 8×8 pixel sub block and other 8×8 pixel sub blocks located clockwise from the leftmost 8×8 pixel sub block, and
the first sub block Bₖ is divided into four second 4×4 pixel sub blocks including a leftmost 4×4 pixel sub block and other 4×4 pixel sub blocks located clockwise from the leftmost 4×4 pixel sub block, and
first through fourth motion vectors correspond to the four sub blocks,
wherein the block mode determination unit determines a block mode for the video data block as an 8×8 block mode when all of the first through fourth motion vectors are similar.

53. The apparatus of claim 51, wherein the block mode determination unit determines a block mode for the first sub block Bₖ as an 8×4 block mode when the first and second motion vectors are similar and the third and fourth motion vectors are similar.

54. The apparatus of claim 51, wherein the block mode determination unit determines a block mode for the first sub block Bₖ as a 4×8 block mode when the first and third motion vectors are similar and the second and fourth motion vectors are similar.

55. The apparatus of claim 51, wherein the block mode determination unit determines a block mode for the first sub block Bₖ as a 4×4 block mode, when a pair of adjacent second sub blocks whose motion vectors are similar is not present, or when motion vectors of a pair of adjacent second sub blocks are not similar although motion vectors of the other pair of adjacent second sub blocks are similar.

56. The apparatus of claim 51, wherein the block mode determination unit compares the amount of data obtained by performing motion estimation on the first sub block Bₖ in the block mode and the amount of data obtained by performing motion estimation on the first sub block Bₖ in the mode of the second sub blocks, and
determines a block mode, which is used when obtaining a lesser amount of data, as a block mode of the first sub block Bₖ.

57. A computer readable recording medium for recording a program that executes a method of determining a reference picture and a block mode, wherein the method comprises:
(a) dividing a video data block of a predetermined size into 2M first sub blocks, wherein M is an integer that equals or is larger than 1;
(b) selecting reference pictures for motion estimation on the respective 2M first sub blocks from N reference pictures, wherein N is an integer that equals or is larger than 2;
(c) counting a number of the first sub blocks that use the same reference picture;
(d) determining whether there are two adjacent first sub blocks using the same reference picture when the number of the first sub blocks using the same reference picture is two or more and is (2M−1) or less; and
(e) when there are two adjacent first sub blocks using the same reference picture, determining a reference picture and a block mode depending on whether two motion vectors are similar, the two motion vectors obtained by performing motion estimation on the two respective adjacent first sub blocks.

58. A computer readable recording medium for recording a program that executes a method of determining a block mode, wherein the method comprises:
(a) determining values of a measure function and motion vectors of respective first sub blocks by performing motion estimation on an input video block in a mode of the first sub blocks, using a predetermined reference picture and the measure function for motion estimation;
(b) determining whether the input video data block in a mode of second sub blocks that is smaller than the mode of the first sub blocks; and
(c) determining a block mode for the input video data block depending on whether motion vectors of the first sub blocks are similar when there is no need to perform motion estimation on the input video data block in the mode of the second sub blocks.
